(19) United States
(12) Patent Application Publication
(10) Pub. No.: US 2013/0078090 A1
(43) Pub. Date: Mar. 28, 2013

(54) AIR CYCLE MACHINE SHAFT SUPPORT ASSEMBLY

(71) Applicants: Craig A. Beers, Wethersfield, CT (US); Darryl A. Colson, West Suffield, CT (US)

(72) Inventors: Craig A. Beers, Wethersfield, CT (US); Darryl A. Colson, West Suffield, CT (US)

(21) Appl. No.: 13/240,001

(22) Filed: Sep. 22, 2011

(51) Int. Cl. F01D 25/16; B23P 15/00; F01D 25/00

(52) U.S. Cl. 415/230; 415/229; 29/888.024

(57) ABSTRACT

An exemplary air cycle machine bearing housing includes a housing establishing a bore that receives a bearing. The bearing rotatably supports an air cycle machine shaft. The bore has an axial length and a radial diameter. A ratio of the axial length to the radial diameter is from 0.6989 to 0.7128.

### BACKGROUND

This disclosure relates to supporting a shaft of an air cycle machine. The air cycle machine supplies air to an aircraft cabin, for example.

As known, air cycle machines include at least a turbine section and a compressor section. A shaft assembly rotatably couples a turbine rotor in the turbine section to a compressor rotor in the compressor section.

Bearings, such as journal bearings, support the shaft assembly. The bearings are held within a bore. Seals limit movement of relatively hot air toward the bearings. Dimensions of the bore and the seals influence the efficiency of the shaft assembly during operation of the air cycle machine.

### SUMMARY

An exemplary air cycle machine bearing housing includes a housing establishing a bore that receives a bearing. The bearing rotatably supports an air cycle machine shaft. The bore has an axial length and a radial diameter. A ratio of the axial length to the radial diameter is from 0.6989 to 0.7128.

An exemplary air cycle machine seal body assembly includes a seal body having a seal land surface that engages a rotating surface of a component. The seal land surface is defined as an area of the seal body that faces radially inward and extends axially between a first end of the seal body and a second opposite end of the seal body. A ratio of a diameter of the seal land surface to a diameter of the component is from 1.0013 to 1.0030.

An exemplary method of installing a shaft in an air cycle machine includes providing a housing establishing a bore adapted to receive a bearing that rotatably supports an air cycle machine shaft. The bore has an axial length and a radial diameter. A ratio of the axial length to the radial diameter is from 0.6989 to 0.7128. The method includes positioning the bearing within the bore and supporting the air cycle machine shaft using the bearing.

### DESCRIPTION OF THE FIGURES

The various features and advantages of the disclosed examples will become apparent to those skilled in the art from the detailed description. The figures that accompany the detailed description can be briefly described as follows:

FIG. 1 shows a perspective view of an example air cycle machine.

FIG. 2 shows a section view at line 2-2 in FIG. 1.

FIG. 3 shows a close-up view of area 3 in FIG. 2 with portions of a shaft assembly removed.

FIG. 4 shows a perspective view of a seal land within the FIG. 1 air cycle machine.

### DETAILED DESCRIPTION

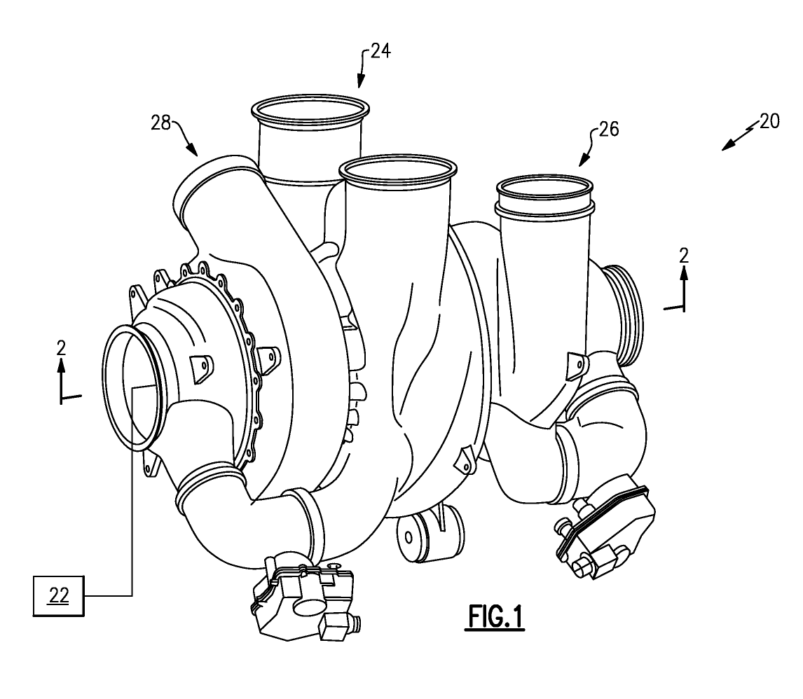

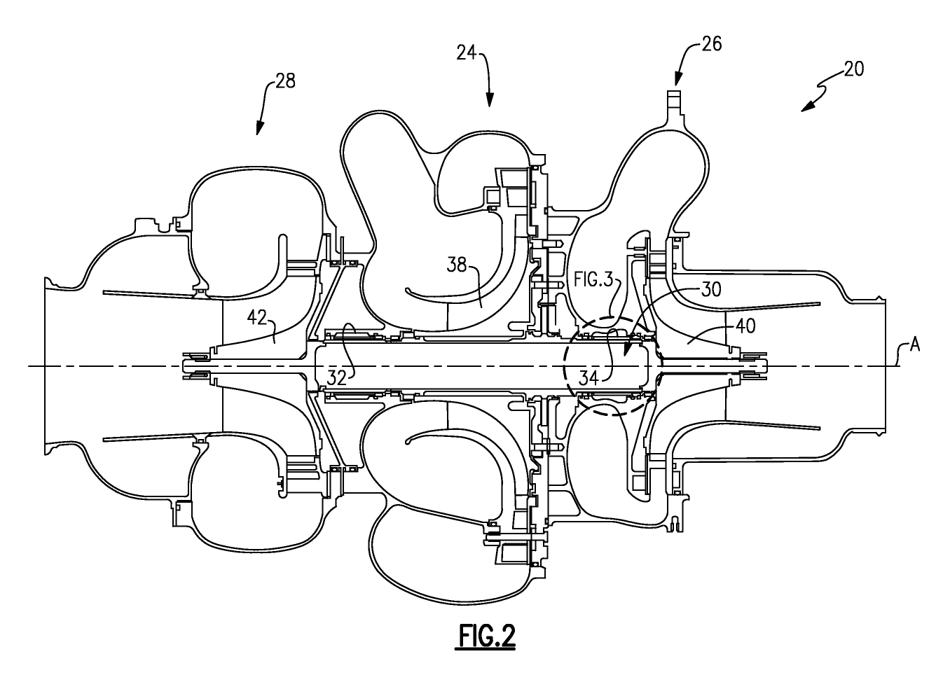

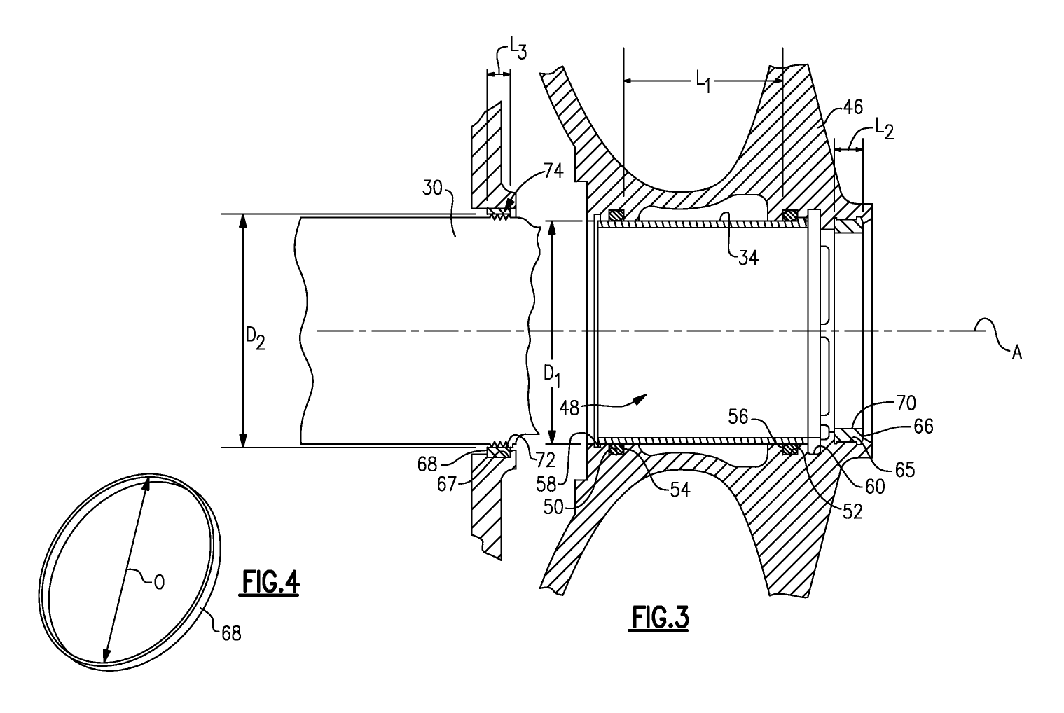

FIGS. 1 and 2 show an example air cycle machine 20 (“ACM”) that is incorporated into an air supply system 22 of a vehicle, such as an aircraft, helicopter, or land-based vehicle. In this example, the ACM 20 supplies air to an aircraft cabin.

The example ACM 20 includes a compressor section 24, a first turbine section 26, and a second turbine section 28. A main shaft assembly 30 extends through the ACM 20 along an axis A. Journal bearings 32 and 34 rotatably support the main shaft assembly 30.

The compressor section 24 includes a compressor rotor 38. The first turbine section 26 includes a turbine rotor 40. The second turbine section 28 includes a turbine rotor 42. The compressor rotor 38 and the turbine rotors 40 and 42 rotate together with the main shaft assembly 30 about the axis A.

Referring to FIG. 3, with continuing reference to FIGS. 1 and 2, a housing 46 of the first turbine section 26 establishes a bore 48. The housing 46 may be cast from aluminum, for example. The first turbine section 26 is a first-stage turbine in this example.

The journal bearings 34 are held within the bore 48 of the housing 46. Also, grooves 50 and 52 in the housing 46 hold a first O-ring seal 54 and a second O-ring seal 56. The O-ring seals 54 and 56 circumscribe opposing axial ends of the journal bearing 34. The O-ring seals 54 and 56 limit movement of fluid and debris into the journal bearing 34.

The grooves 50 and 52 generally define the opposing axial ends of the bore 48. The journal bearing 34, however, may extend axially past the grooves 50 and 52.

The radially outer periphery of the example journal bearing 34 is cylindrical and established by a steel sleeve. Other examples bearings suitably for rotatably supporting the main shaft assembly 30 include foil bearings.

A groove 58 in the housing 46 holds a snap ring (not shown) that helps holds the journal bearing 34 in an installed position. The groove 58 is axially outside the groove 52 relative to an axial center of the bore 48.

Another groove 60 in the housing 46 provides relief for the journal bearing 34 in the installed position. The groove 60 is axially outside the groove 50 relative to the axial center of the bore 48.

A length L₁ represents the axial distance of the bore 48, which is generally the distance between the groove 50 and the groove 52. In this example, the length L₁ is from 4.016 to 4.092 centimeters (1.581 to 1.611 inches).

A diameter D₁ represents the radial size of the bore 48 in the axial areas where the housing 46 contacts the journal bearing 34. In this example, the diameter D₁ is from 5.7404 to 5.7455 centimeters (2.260 to 2.262 inches).

The ratio of the bore length L₁ to the bore diameter D₁ is controlled. In this example, the ratio of the bore length L₁ to the bore diameter D₁ is from 0.6989 to 0.7128.

The housing 46 of the first turbine section 26 defines a recess 65 that holds a first seal 66 and another recess 67 that holds a second seal 68. During operation, the shaft assembly 30 rotates relative to the first and second seals 66 and 68.

The example first and second seals 66 and 68 are made of a polyamide material in this example. Slight interferences between the first and second seals 66 and 68, and the housing 46 hold the first and second seals 66 and 68 within the respective recess.

Radially inward facing seal land surfaces 70 and 72 of the first and second seals 66 and 68 directly contact radially outwardly facing surfaces of the shaft assembly 30. The surfaces 70 and 72 have axial lengths L₂ and L₃, respectively.

The axial length L₂ extends from a first axial end of the surface 70 to a second opposite axial end of the surface 70. The axial length L₃ extends from a first axial end of the surface 72 to a second opposite axial end of the surface 72.

In some examples, the portion of the shaft assembly 30 that interfaces with the first seal 66 includes a ribbed area 74, which helps limit relative axial movement between the first seal 66 and the shaft assembly 30. The ribs of the ribbed area 74 extend radially outward away from the axis A. The portion of the shaft assembly 30 received within the second seal 68 also may include ribbed areas.

The portion of the shaft assembly 30 received within the first seal 66 has a diameter D₂ The ribs of the ribbed area 74 are included in the diameter D₂.

The first and second seals 66 and 68 limit movement of relatively hot air toward the journal bearing 34. The relatively hot air can overheat the journal bearing 34.

The first and second seals 66 and 68 each have an opening that receives the shaft assembly 30. The size of the opening of the second seal is represented by a distance O, which is from 0.03048 to 0.04064 millimeters (0.0012 to 0.0016 inches) larger than the diameter D₂. The size of the opening in the first seal 66 is also from 0.03048 to 0.04064 millimeters (0.0012 to 0.0016 inches) larger than the diameter of the portion of the shaft assembly 30 received within the first seal 66.

Designing the seals 66 and 68 to have openings from 0.03048 to 0.04064 millimeters (0.0012 to 0.0016 inches) larger that the received portion of the shaft assembly 30 helps reduce seal wear while still providing adequate sealing function.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An air cycle machine bearing housing, comprising:
a housing establishing a bore adapted to receive a bearing that rotatably supports an air cycle machine shaft, wherein the bore has an axial length and a radial diameter, wherein a ratio of the axial length to the radial diameter is from 0.6989 to 0.7128.

2. The air cycle machine bearing housing of claim 1, wherein the axial length is from 1.581 to 1.611 centimeters (4.016 to 4.092 inches).

3. The air cycle machine bearing housing of claim 1, wherein the radial diameter is from 5.740 to 5.745 centimeters (14.590 to 14.592 inches).

4. The air cycle machine bearing housing of claim 1, wherein the housing is comprised of an aluminum material.

5. The air cycle machine bearing housing of claim 1, wherein the bearing comprises a journal bearing.

6. The air cycle machine bearing housing of claim 1, wherein the housing is a first-stage turbine housing.

7. The air cycle machine bearing housing of claim 1, wherein a first axial end of the bore is defined by a first seal groove and a second opposite end of the bore is defined by a second seal groove.

8. The air cycle machine bearing housing of claim 7, wherein the first and second seal grooves are each configured to receive and O-ring seal.

9. An air cycle machine seal body assembly, comprising:
a seal body having a seal land surface to engage a rotating surface of a component, wherein the seal land surface is defined as an area of the seal body that faces radially inward and extends axially between a first end of the seal body and a second opposite end of the seal body, wherein a ratio of a diameter of the seal land surface to a diameter of the component is from 1.0013 to 1.0030.

10. The air cycle machine seal body assembly of claim 9, wherein the seal body is comprised of a polyimide material.

11. The air cycle machine seal body assembly of claim 9, wherein the seal body comprises a non-rotating component.

12. The air cycle machine seal body assembly of claim 9, wherein the seal land comprises a surface circumferentially arranged about a rotational axis of the rotating surface, and the seal land surface is to directly engage the rotating surface when installed.

13. The air cycle machine seal body assembly of claim 9, wherein the seal body is received within a bore of a turbine section within an air cycle machine.

14. A method of installing a shaft in an air cycle machine comprising:
(a) providing a housing establishing a bore adapted to receive a bearing that rotatably supports an air cycle machine shaft, wherein the bore has an axial length and a radial diameter, wherein a ratio of the axial length to the radial diameter is from 0.6989 to 0.7128;
(b) positioning the bearing within the bore; and
(c) supporting the air cycle machine shaft using the bearing.

15. The method of claim 14, including:
(d) providing a seal body having a seal land surface to engage a rotating surface of a component, wherein the seal land surface is defined as an area of the seal body that faces radially inward and extends axially between a first end of the seal body and a second opposite end of the seal body, wherein a ratio of a diameter of the seal land surface to a diameter of the component is from 1.0013 to 1.0030;
(e) positioning the air cycle machine shaft within the seal body; and
(f) supporting the seal body with the housing.
